(19) United States
(12) Patent Application Publication
(10) Pub. No.: US 2009/0168831 A1
(43) Pub. Date: Jul. 2, 2009

(54) ELECTRIC ARC FURNACE ROOF TOP AND CENTRAL PORTION FOR THIS ROOF TOP

(75) Inventors: Serge Fontaine, Hyon (BE); Paolo Esposito, Quaregnon (BE)

Correspondence Address: Vesuvius Crucible Company, 250 Park West Drive, Pittsburgh, PA, 15275, US

(73) Assignee: VESUVIUS CRUCIBLE COMPANY, Wilmington, DE (US)

(21) Appl. No.: 12/374,369

(22) PCT Filed: Jul. 20, 2007
(86) PCT No.: PCT/EP2007/006481

§ 371 Date: Jan. 19, 2009

(30) Foreign Application Priority Data
Jul. 20, 2006 (EP) 06117550

(51) Int. Cl. F27B 3/16; F27D 1/02

(52) U.S. Cl. 373/73; 432/237

(57) ABSTRACT

An electric arc roof furnace top contains a central portion and a peripheral portion surrounding the central portion. Each of these portions has an inner surface suitable for facing the furnace inner space. The inner surfaces of the peripheral and central portions form together a step so as to raise the inner surface of the central portion in relation to the inner surface of the peripheral portion with respect to the furnace inner space.

### BACKGROUND OF THE INVENTION

1. Field of the Invention

The present invention relates to an electric arc furnace roof top and to a central portion for an electric arc furnace roof top.

2. Description of the Related Art

DE 41 00 960 shows an electric arc furnace comprising a closed tank delimiting the inner space of the furnace. This tank comprises an upper roof provided with an opening for accessing the furnace inner space. This opening is generally closed by a roof top. The roof top is generally disk-shaped and has a concave inner surface. The roof top, made from refractory materials suitable for sustaining high temperatures is provided with orifices permitting the passage of electrodes intended for generating the electric arc inside the furnace.

It is known that the roof top is one of the furnace portions which are particularly exposed to the heat of the electric arc because this electric arc is mainly produced in regard of the roof top inner surface, while it is more remote from the inner surface of the other tank portions. The roof top inner surface is thus more prone to wearing. Consequently, the roof top must periodically be replaced during the lifetime of the furnace. Electric arc furnace roof tops are also known from the Japanese patent applications (Kokai) 54-023006 and 54-014308. The roof top is comprised of a central portion made from a refractory material surrounded by a metal casing. The rooftop is comprised of a monoblock element made from a refractory material which, when worn, must be wholly replaced.

However, the roof top is an element which is particularly heavy and largely sized so that its replacement is difficult and expensive, notably when the replacement roof top must be transported from the fabrication location to the electric arc furnace location.

### DESCRIPTION OF THE RELATED ART

The present invention aims at remedying this difficulty by providing a roof top less prone to wearing so as to require less frequent replacement. Moreover, the present invention aims at providing an electric arc furnace roof top that is easier and less expensive to transport.

To this end, an object of the invention is an electric arc furnace roof top suitable for closing an opening for accessing a furnace inner space provided in an upper roof of the furnace, characterized in that the roof top comprises a central portion and a peripheral portion surrounding the central portion, each of these portions having an inner surface suitable for facing the furnace inner space, the central portion and the peripheral portion being made from a refractory material suitable for sustaining high temperatures, and the inner surfaces of the peripheral and central portions forming together a step so as to raise the inner surface of the central portion in relation to the inner surface of the peripheral portion with respect to the inner space of the furnace.

Thereby, thanks to the step formed by the inner surfaces of the central and peripheral portions, the roof top according to the invention is less sensitive to the highest temperature region generated by the electric arc at the center of the furnace since the portion of the roof top more prone to wearing is also more remote. Consequently, the roof top erodes more slowly than in the state of the art.

Moreover, the inner surface of the roof top peripheral portion can be located at the same height, with respect to the furnace inner space, as in the state of the art so that it is not necessary to modify existing furnaces.

Thanks to the invention, the life of the roof top is longer than in the state of the art, without any necessity for material addition.

According to the invention, the roof top can have one or more of the following characteristics:

The central portion inner surface is substantially flat. Indeed, since the central portion inner surface is higher than the peripheral portion inner surface, it is not necessary for it to be concave, while the inner surface of the state of the art roof top is generally concave. As is known, it is easier to manufacture flat surfaces than concave surfaces, especially for elements of such a size and the roof top according to the invention is easier to produce.

The central and peripheral parts are applied one onto the other. Several advantages arise therefrom. First, when the roof top is worn, it is possible to only replace the central portion which is less voluminous and lighter than the full roof top. Further, since the central and peripheral portions are applied one onto the other, it is possible to manufacture a standard central portion which will be the same whatever the furnace where the roof top is to be installed, the peripheral portion permitting to adapt the roof top to the size of each furnace. Thereby, the central portion which is likely the most often replaced portion of the furnace is the same whatever the furnace. It is thus less expensive to manufacture.

The central and peripheral portions comprise complementary matching revolution surfaces provided with mutual positioning means of the central and peripheral portions. Thereby, these positioning means facilitate the assembly of the central portion with the peripheral portion, particularly when only the central portion of the roof top is replaced.

At least one of the matching surfaces of the central and peripheral portions comprises an axial and radial mutual positioning shoulder of the portions, cooperating with a complementary portion of the other of these matching surfaces. Thanks to this shoulder, provided either on the central portion or on the peripheral portion, the axial and radial mutual positioning of the portions is particularly easy and does not require further means. Further, the tightness of the furnace is thereby improved.

The complementary matching surfaces have generally frustoconical shapes. Despite manufacturing tolerances of the central and peripheral portions, the complementary matching surfaces ensure an axial and radial mutual positioning, while ensuring efficiently the tightness of the furnace.

The peripheral portion has a general ring shape constituted by the assembly of at least two segments, preferably three segments. This embodiment is particularly interesting since it is possible to have distinct segments separated before the assembly of the roof top in the furnace, notably for its transportation. Now, it is known that the diameter of the peripheral portion is quite large. Thanks to the invention, the volume saved is particularly significant. Moreover, if only one of these segments is damaged, it is possible to replace just this segment.

The roof top comprises joining means joining the segments together. Thereby, the peripheral portion can be shaped as a monoblock while it has been transported as separated segments. Further, thanks to such joining means, once the top roof is applied on the furnace, it is possible to dismount the central portion from the peripheral portion, this last portion remaining mounted on the furnace without having to separate the segments.

The joining means comprise a belt surrounding the segments. This belt might not only ensure the junction of the segments together but also the junction of the roof top with the furnace roof.

The belt bears anchoring means for a top roof lifting apparatus. Indeed, it might be easier to have such anchoring means on the belt rather than on the central or peripheral portion.

Another object of the invention is a central portion for an electric arc furnace roof top, characterized in that the central portion is suitable for forming the central portion of a roof top as above defined.

### BRIEF DESCRIPTION OF THE SEVERAL VIEWS OF THE DRAWINGS

The invention will be better understood in light of the following description only submitted for the sake of illustration and provided in relation to the figures wherein:

FIG. 1 is a cut view of a roof top according to a first embodiment of the invention, according to the plane I-I of FIG. 2;

FIG. 2 is a top view of the roof top of FIG. 1;

FIG. 3 is a perspective bottom view of the roof top of FIG. 1; and

FIG. 4 is a cut view of a roof top according to a second embodiment of the invention.

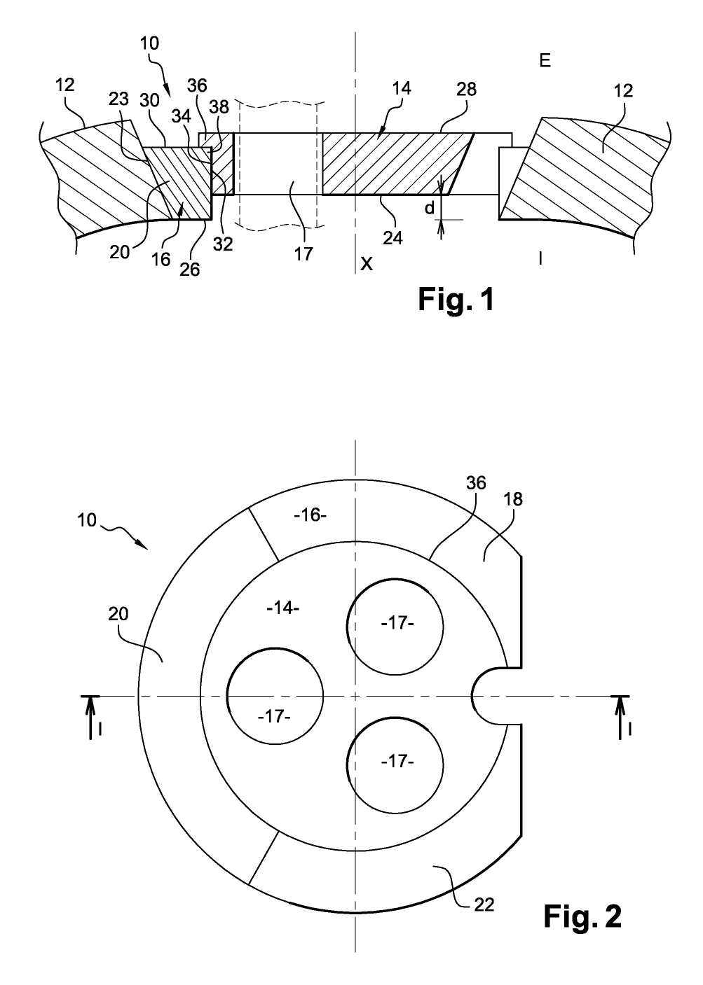

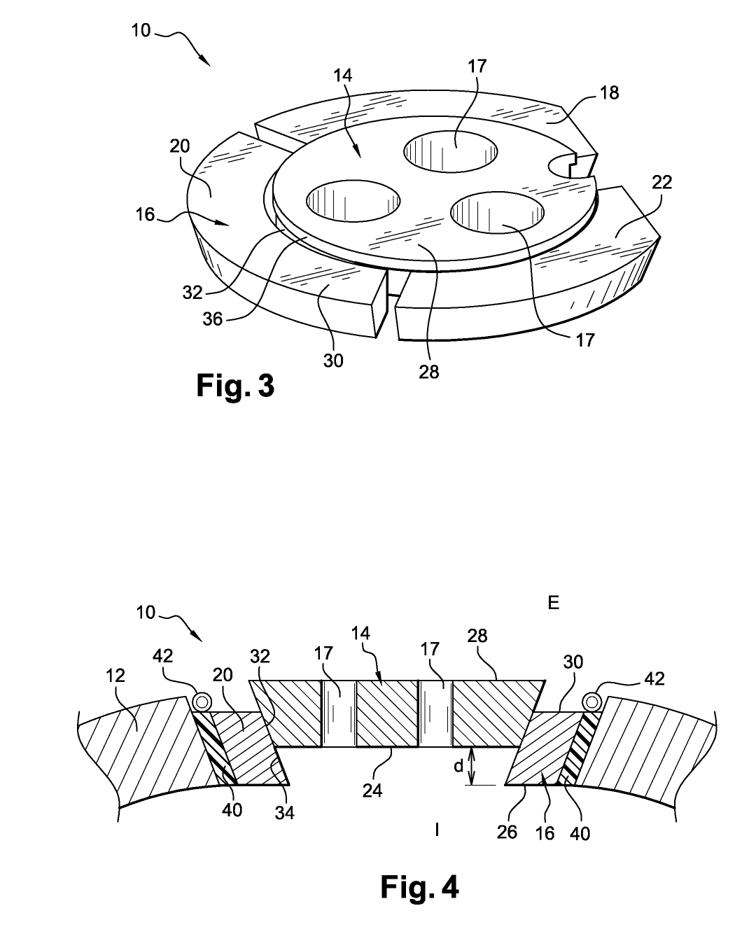

An electric arc furnace roof top 10 according to a first embodiment of the invention is shown on FIGS. 1 to 3.

The electric arc furnace comprises a globally closed tank having a general revolution shape around an axis X. The tank comprises an upper roof 12 of which only a portion is shown on FIG. 1. The roof 12, separating the inside I from the outside E of the furnace is provided with an opening for accessing the furnace inner space, which is closed by the roof top 10.

The roof top 10 comprises a central portion 14 and a peripheral portion 16 surrounding the central portion, applied one onto the other, each being made from a refractory material suitable for sustaining high temperatures.

The central portion 14 is generally disk-shaped, the axis of the disk being substantially identical with the axis X of the furnace so that the central portion 14 is arranged in front of the center of the furnace where the electric arcs are generated. This portion 14 is provided with three openings 17 for the passage of electrodes intended for generating electric arcs inside the furnace; one of these electrodes is partially depicted in dashed line on FIG. 1.

The peripheral portion 16 has the general shape of a ring constituted by the junction of three segments 18, 20, 22 thanks to joining means joining the segments together. The joining means comprise for example, refractory mortar with 90% of alumina. The portion 16 is provided with a surface 23 for the junction of the roof 12 with the roof top, cooperating with a complementary surface 23 of the roof 12.

The central portion 14 and the peripheral portion 16 are each provided with an inner surface 24, 26 suitable for facing the furnace inner space 1, and with an outer surface 28, 30 suitable for facing the furnace outer space E, each of the surfaces 24, 26, 28, 30 being substantially planar.

As can be seen in FIG. 1, the inner surfaces of the peripheral and central portions 16, 14 form together a step d so as to raise the inner surface 24 of the central portion in relation to the inner surface 26 of the peripheral portion with respect to the furnace inner space 1.

The central and peripheral portions 14, 16 further comprise respective complementary matching revolution surfaces 32, 34. These surfaces are provided with mutual axial and radial positioning means 36, 38 of the central and peripheral portions 14, 16. These means comprise a shoulder 36 arranged on the matching surface 32 of the portion 14 cooperating with a complementary portion 38 of the matching surface 34 of the peripheral portion 16.

The main aspects of a process for the assembly of a roof top according to the invention and its mounting on an electric arc furnace will now be described.

Firstly, the components of the roof top are brought near the furnace. Preferably, these components are not yet assembled so that the central portion 14 and each of the segments 18, 20, 22 can be transported separately.

The roof top 10 is then assembled by joining together the segments 18, 20, 22 with joining means. The peripheral portion 16 is then installed in the opening of the upper roof 12 by making the complementary junction surfaces 23 to cooperate.

Once the peripheral portion 16 is assembled and mounted on the furnace, the central portion 14 is fit on the top of it so as to finish the assembly of the roof top on the furnace. Optionally, the two portions 14, 16 can be made integral with joining means.

If later, it is desired to replace the central portion 14 of the roof top, notably for wear reasons, it is sufficient to replace the central portion 14 without dismounting the peripheral portion 16 of the furnace.

FIG. 4 shows a second embodiment of the roof top 10. The elements similar to those of FIGS. 1 to 3 are referred to by identical reference numbers.

Contrary to the first embodiment, the complementary matching surfaces 32, 34 of the central and peripheral portions 14, 16 have generally frustoconical shapes. These surfaces constitute mutual positioning means of the central and peripheral portions 14, 16.

Moreover, the joining means comprise a belt 40 surrounding the segments 8, 20, 22. The belt 40 bears anchoring means 42 for a top roof lifting apparatus.

The process for the mounting of the roof top 10 of FIG. 4 is similar to that of the roof top of FIGS. 1 to 3. However, the belt is used to join the segments 18, 20, 22 together. Further joining means such as a refractory mortar can also be used; this permits the dismounting of central portion 14 from the furnace without removing the segments of the peripheral portion 16.

Amongst the advantages of the invention, it will be noted that a roof top 10 has been provided with a shape essentially matching the wear profile generated by the electric arc at the center of the furnace so that the central portion 14 of the roof top wears less quickly than in the state of the art. Further, the central portion 14 can be made standard whatever the dimensions of the furnace where the roof top is to be mounted. Finally, it will be understood that the segments 18, 20, 22 being separated, permit a much easier transportation of the peripheral portion 16.

Numerous modifications and variations of the present invention are possible. It is, therefore, to be understood that within the scope of the following claims, the invention may be practiced otherwise than as specifically described.

1.-11. (canceled)

12. Electric arc furnace roof top suitable for closing an opening for accessing a furnace inner space provided in an upper roof of a furnace, wherein the roof top comprises a central portion and a peripheral portion surrounding the central portion, each of these portions having an inner surface suitable for facing the furnace inner space, wherein the central portion and the peripheral portion are made from a refractory material suitable for sustaining high temperatures, and wherein the inner surfaces of the peripheral and central portions form together a step so as to raise the inner surface of the central portion in relation to the inner surface of the peripheral portion with respect to the furnace inner space.

13. Roof top according to claim 12, wherein the central portion inner surface is substantially flat.

14. Roof top according to claim 12, wherein the central and peripheral portions are applied one onto the other.

15. Roof top according to claim 14, wherein the central and peripheral portions comprise complementary matching revolution surfaces provided with mutual positioning means of the central and peripheral portions.

16. Roof top according to claim 15, wherein at least one of the matching surfaces of the central and peripheral portions comprises an axial and radial mutual positioning shoulder of the portions, cooperating with a complementary portion of the other of these matching surfaces.

17. Roof top according to claim 15, wherein the complementary matching surfaces have generally frustoconical shapes.

18. Roof top according to claim 14, wherein the peripheral portion has a general ring shape constituted by the assembly of at least two segments.

19. Roof top according to claim 14, wherein the peripheral portion has a general ring shape constituted by the assembly of at least three segments.

20. Roof top according to claim 18, further comprising joining means joining the segments together.

21. Roof top according to claim 20, wherein the joining means comprise a belt surrounding the segments.

22. Roof top according to claim 21, wherein the belt bears anchoring means for a top roof lifting apparatus.

23. Central portion for an electric arc furnace roof top, wherein the central portion is suitable for forming the central portion of a roof top according to claim 14.
